(19) United States
(12) Patent Application Publication
(10) Pub. No.: US 2026/0367266 A1
(43) Pub. Date: Nov. 19, 2026

(54) UNMANNED SENSING AND DETECTION SYSTEM AND METHOD FOR UNDERGROUND SPACES

(71) Applicants: Yunlong Lake Lab of Deep Underground Sci. & Eng., Xuzhou City (CN); China University of Mining and Technology, Xuzhou City (CN)

(72) Inventors: Bo WANG, Xuzhou City (CN); Sihongren SHEN, Xuzhou City (CN); Zhenyao GAO, Xuzhou City (CN); Xiaozhao LI, Xuzhou City (CN); Linfeng ZENG, Xuzhou City (CN); Ying WANG, Xuzhou City (CN)

(73) Assignees: Yunlong Lake Lab of Deep Underground Sci. & Eng., Xuzhou City, JI (CN); China University of Mining and Technology, Xuzhou City, JI (CN)

(21) Appl. No.: 19/323,070

(22) Filed: Sep. 9, 2025

(30) Foreign Application Priority Data
May 15, 2025 (CN) 202510623406.3

(51) Int. Cl. G01V 1/09; B64U 70/93; B64U 101/35; G01V 1/143; G01V 1/18; G01V 1/30

(52) U.S. Cl. CPC G01V 1/09; B64U 70/93; G01V 1/143; G01V 1/184; G01V 1/301; B64U 2101/35; G01V 2210/121; G01V 2210/1299; G01V 2210/1429; G01V 2210/6163; G01V 2210/66

(57) ABSTRACT

Provided are an unmanned sensing and detection system and method for underground spaces. The method includes: obtaining, by an unmanned detection carrier platform, surface data of the underground space via a sensing radar gimbal and an unmanned aerial vehicle; determining a to-be-detected target area and planning a traveling path according to the obtained data; placing, by a robotic arm, ad hoc network relay nodes on different positions of the unmanned detection carrier platform in combination with signal strength to finally form an ad hoc network, ensuring normal communication between the unmanned detection carrier platform and the unmanned aerial vehicle in the underground space; when the unmanned detection carrier platform travels to the target area, forming a seismic observation system by deploying the nodal geophone, and separately starting an active seismic source and a transient electromagnetic detection apparatus to obtain seismic wave data and transient electromagnetic data of the target area.

### CROSS REFERENCE TO RELATED APPLICATION

This patent application claims the benefit and priority of Chinese Patent Application No. 2025106234063, filed with the China National Intellectual Property Administration on May 15, 2025, the disclosure of which is incorporated by reference herein in its entirety as part of the present application.

### TECHNICAL FIELD

The present disclosure belongs to the field of unmanned detection technologies for underground spaces, and specifically, relates to an unmanned sensing and detection system and method for underground spaces.

### BACKGROUND

A seismic detection method for a geological structure usually relies on seismic wave excitation and reception technologies, and an underground structure is inferred by analyzing propagation characteristics of seismic waves in underground media. An existing seismic detection technology usually requires complex manual operations, for example, manually deploying seismic sources and receiving devices at designated positions. This leads to low working efficiency and high reliance on operation personnel. However, in complex underground space, it is possible that the operation personnel cannot enter environments such as a toxic-atmosphere environment, a confined passage, or an environment with collapse hazards. This significantly increases manual deployment and operation difficulty of a conventional detection device, and consequently constrains both coverage and detection precision of seismic detection in the underground space.

At present, robots on the market can replace manual operation, but mostly have single functions and are insufficient in stability. Without a self-networking capability, a robot that is configured to perform positioning and signal transmission via a global positioning system (GPS) has difficulty in operating in the underground space. In addition, an existing robot is mainly operated manually. Furthermore, the existing robot is mainly configured to sense a surface environment of surrounding space, and there is no solution in which robot technologies are integrated with geophysical exploration. Integrating robots with geophysical exploration is confronted with a plurality of difficulties and challenges. In seismic detection, due to limitation of unmanned operations, an existing geophone cannot be autonomously fastened to a side wall and a ceiling of the underground space. Consequently, the seismic detection is limited, and it is difficult to comprehensively detect geological structures in all directions of the underground space.

Therefore, a key research focus in this field is to provide an apparatus and a method, to implement sensing modeling for the underground space in an unmanned manner, and perform unmanned signal excitation, reception, and processing via a seismic device and a transit electromagnetic device, so as to obtain more accurate geological structure information.

### SUMMARY

The present disclosure provides an unmanned sensing and detection system and method for underground spaces, to effectively resolve the technical problem in the conventional technology.

To achieve the objective, the present disclosure adopts the following technical solution: An unmanned sensing and detection system for underground spaces includes an unmanned detection carrier platform, a control apparatus, a sensing radar gimbal, a robotic arm, an active seismic source, a nodal geophone, an ad hoc network relay node, and a transient electromagnetic detection apparatus, where
the nodal geophone, the ad hoc network relay node, and the transient electromagnetic detection apparatus are all disposed on the unmanned detection carrier platform, and the sensing radar gimbal is disposed on the unmanned detection carrier platform, and is configured to obtain ambient environmental data; and the robotic arm is disposed on the unmanned detection carrier platform, and is configured to: place the nodal geophone and the ad hoc network relay node on required positions, and move the transient electromagnetic detection apparatus to a required position for transient electromagnetic detection;
the active seismic source is disposed beside the unmanned detection carrier platform through a rotating mechanism, and is configured to excite seismic waves in different directions via the rotating mechanism according to needs; and
the control apparatus is connected to the sensing radar gimbal, the nodal geophone, the robotic arm, the rotating mechanism, and the active seismic source, and is configured to: receive environmental data and seismic wave data fed back by the sensing radar gimbal and the nodal geophone, control an action of the robotic arm, and control the rotating mechanism to adjust an excitation direction of the active seismic source.

Further, a droneport is disposed on the unmanned detection carrier platform, an unmanned aerial vehicle is stationed on the droneport, and the unmanned aerial vehicle is configured to carry a sensing device to sense the underground space to obtain data, and carry the nodal geophone to fly to a side wall or a ceiling of the underground space to construct a seismic observation system.

Further, a crawler track is disposed on a lower part of the unmanned detection carrier platform, and is configured to move the unmanned detection carrier platform.

Further, there are a plurality of nodal geophones, and the plurality of nodal geophones are deployed to form a seismic observation system for receiving seismic wave data excited by the active seismic source.

Further, a wireless communication module is disposed in the control apparatus; there are a plurality of ad hoc network relay nodes, the plurality of ad hoc network relay nodes are deployed to form an ad hoc network, and the control apparatus is in a wireless connection to a ground monitoring center through the ad hoc network; and a signal strength detection module is disposed in the ad hoc network relay node, and is configured to: measure signal strength of a position at which the ad hoc network relay node is located, and feed back the signal strength to the control apparatus; and the control apparatus is configured to determine a placing position of the ad hoc network relay node according to the signal strength.

Further, the ad hoc network relay node is provided with a global positioning system (GPS) timing module, and a high-precision crystal oscillator timing module; when the ad hoc network relay node is within a signal range of a GPS, timing is performed by the GPS timing module according to a GPS signal; and when the ad hoc network relay node is in a satellite-denied environment, timing is performed by the high-precision crystal oscillator timing module. Time synchronization is kept through timing, and a time error within 24 hours is controlled to be within 2 ms, to meet needs of sensing and detection in the underground space.

Further, the control apparatus is a high-performance computer.

A working method of the unmanned sensing and detection system in underground specifically includes the following steps:
step 1, performing unmanned sensing modeling and network deployment in the underground space: enabling the unmanned sensing and detection system to enter the underground space according to existing underground space documentation; deploying ad hoc network relay nodes according to signal strength in the entering process to construct an ad hoc network of the underground space, to ensure that a ground monitoring center is in continuous wireless communication with a control apparatus; and then, continuously sensing surface data (for example, space, temperature, humidity, and gas) of the underground space through cooperation between a sensing radar gimbal of the unmanned sensing and detection system and an unmanned aerial vehicle, and feeding back the surface data to the control apparatus to preliminary form a three-dimensional model of the underground space, providing background data and environmental information for subsequent detection;
step 2, determining a target to-be-detected underground area: analyzing, according to the existing underground space documentation and the three-dimensional model established in step 1, probability of potential geological anomalies in surrounding rocks across different areas, and determining a to-be-detected target area;
step 3, deploying a seismic observation system and obtaining transient electromagnetic data: enabling the unmanned sensing and detection system to reach the target area according to the three-dimensional model and a target area planning and navigation path; controlling a robotic arm by the control apparatus to deploy a nodal geophone around the target area, starting the unmanned aerial vehicle to carry the nodal geophone to fly to a ceiling of the underground space of the target area, thereby forming the seismic observation system; and controlling, by the control apparatus in the target area, the robotic arm to move a transient electromagnetic detection apparatus to a target rock mass, and starting the transient electromagnetic detection apparatus to obtain the transient electromagnetic data of the target area;
step 4, exciting an unmanned vector source: moving the unmanned sensing and detection system to a position at which a seismic wave needs to be excited, determining an excitation direction of the seismic wave, and controlling, by the control apparatus, a rotating mechanism to adjust an excitation direction of an active seismic source, to enable the excitation direction to aim at the target rock mass; exciting, by the active seismic source, the seismic wave after the alignment, and continuously receiving, by the seismic observation system, seismic wave data, to complete detection on a current target area;
step 5, retrieving a detection device: returning, by the rotating mechanism, the active seismic source, enabling the unmanned sensing and detection system to move to a position of each nodal geophone, and retrieving, by the robotic arm, the nodal geophone to an unmanned detection carrier platform; and
step 6, continuously detecting in the underground space: continuously repeating step 2 to step 5, continuously detecting, by the unmanned sensing and detection system, different target areas until detection work of the entire underground space is completed; and then, enabling the unmanned sensing and detection system to start exiting the underground space, and starting to sequentially retrieve each ad hoc network relay node from a position of an ad hoc network relay node that is furthest away from an entry of the underground space in an exit process until all ad hoc network relay nodes are retrieved, and the unmanned sensing and detection system completely leaves the underground space.

Further, in step 3, the unmanned aerial vehicle is adsorbed to a ceiling through air pressure, to couple the nodal geophone to a surface of the ceiling. This can ensure precision of data received by the nodal geophone, and also implements a three-dimensional seismic observation system.

Compared with the conventional technology, the present disclosure adopts a manner in which the unmanned detection carrier platform, the unmanned aerial vehicle, the sensing radar gimbal, the robotic arm, the active seismic source, the nodal geophone, the ad hoc network relay node, and the transient electromagnetic detection apparatus are combined. The unmanned detection carrier platform enters the underground space, the surface data of the underground space is obtained via the sensing radar gimbal, and surface data of an area that cannot be entered by the unmanned detection carrier platform is obtained via the unmanned aerial vehicle. Then, the to-be-detected target area is determined according to the obtained data, and the traveling path is planned. In a process in which the unmanned detection carrier platform enters the underground space, the ad hoc network relay nodes are placed on different positions by the robotic arm in combination with signal strength, to finally form the ad hoc network, ensuring normal communication between the unmanned detection carrier platform and the unmanned aerial vehicle in the underground space. When the unmanned detection carrier platform travels to the target area, the nodal geophones are deployed to form the seismic observation system, and the active seismic source and the transient electromagnetic detection apparatus are separately started to obtain seismic wave data and transient electromagnetic data of the target area, and different target areas are continuously detected to complete the entire detection process of the underground space. According to the present disclosure, not only can sensing and modeling of the underground space be achieved in an unmanned manner, but also overall detection data of the underground space can be precisely obtained through unmanned signal excitation, reception, and processing via the seismic device, and the transient electromagnetic device, thereby facilitating subsequent analysis and processing of the underground space data.

### BRIEF DESCRIPTION OF THE DRAWINGS

FIG. 1 is a schematic diagram of an overall deployment according to the present disclosure;

FIGS. 2A-2B are schematic diagrams when an active seismic source is excited according to the present disclosure, where

FIG. 2A shows that a seismic wave is excited in a direction perpendicular to a bottom plate; and FIG. 2B shows that a seismic wave is excited in a direction perpendicular to a side wall; and

FIG. 3 is a schematic diagram in which an unmanned aerial vehicle carries a nodal geophone to fly to a side wall or a ceiling according to the present disclosure.

In the drawings: 1—side wall; 2—ceiling; 3—nodal geophone; 4—sensing radar gimbal; 5—robotic arm; 6—crawler track; 7—unmanned detection carrier platform; 8—active seismic source; 9—droneport; and 10—ad hoc network relay node.

### DETAILED DESCRIPTION OF THE EMBODIMENTS

The present disclosure is further described below.

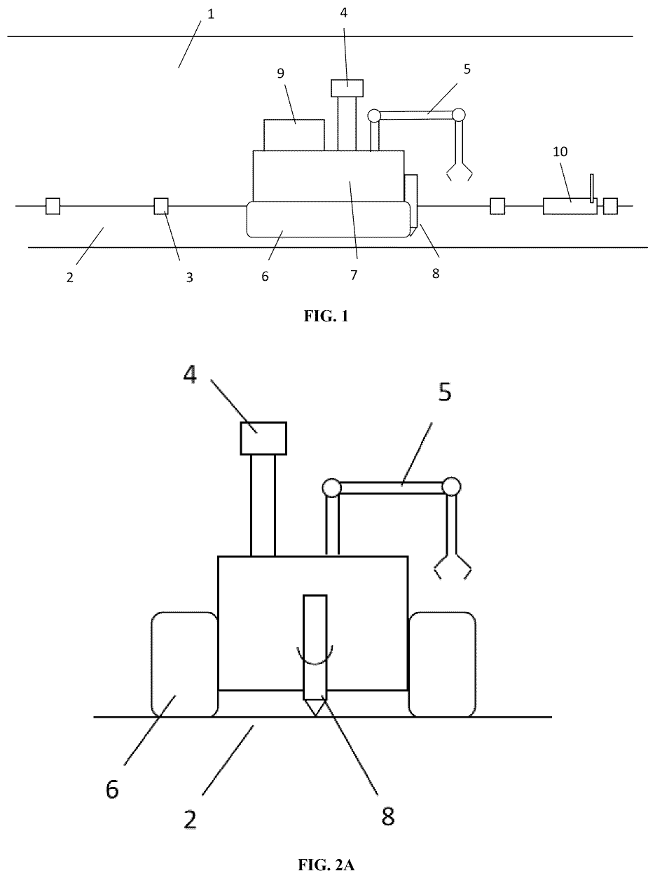

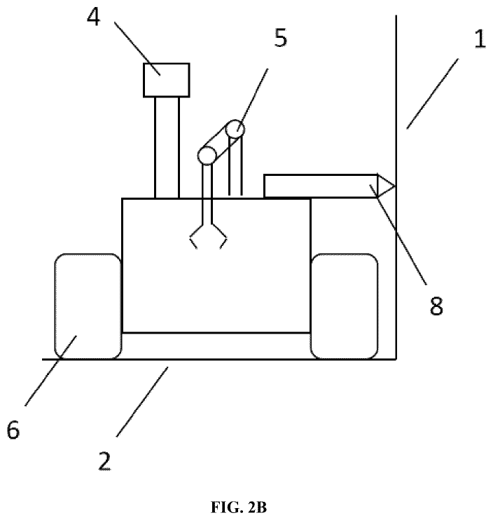

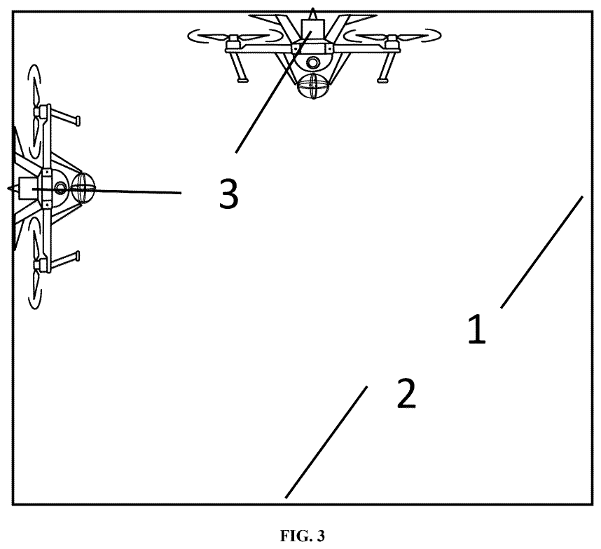

As shown in FIG. 1, an unmanned sensing and detection system for underground spaces includes an unmanned detection carrier platform 7, a control apparatus, a sensing radar gimbal 4, a robotic arm 5, an active seismic source 8, a nodal geophone 3, an ad hoc network relay node 10, and a transient electromagnetic detection apparatus. The control apparatus is a high-performance computer.

The nodal geophone 3, the ad hoc network relay node 10, and the transient electromagnetic detection apparatus are all disposed on the unmanned detection carrier platform 7, and the sensing radar gimbal 4 is disposed on the unmanned detection carrier platform 7, and is configured to obtain ambient environmental data. The robotic arm 5 is disposed on the unmanned detection carrier platform 7, and is configured to: place the nodal geophone 3 and the ad hoc network relay node 10 on required positions, and move the transient electromagnetic detection apparatus to a required position for transient electromagnetic detection. A crawler track 6 is disposed on a lower part of the unmanned detection carrier platform 7, and is configured to move the unmanned detection carrier platform 7. A droneport 9 is disposed on the unmanned detection carrier platform 7, an unmanned aerial vehicle is stationed on the droneport 9, and the unmanned aerial vehicle is configured to carry a sensing device (for example, a photosensitive/infrared camera or a lidar) to sense the underground space to obtain data, and carry the nodal geophone 3 to fly to a side wall 1 or a ceiling 2 of the underground space to construct a seismic observation system. There are a plurality of nodal geophones 3, and the plurality of nodal geophones 3 are deployed to form the seismic observation system for receiving seismic wave data excited by the active seismic source.

The active seismic source 8 is disposed on the unmanned detection carrier platform 7 through a rotating mechanism, and is configured to excite seismic waves in different directions via the rotating mechanism according to needs. The active seismic source 8 is an unmanned vector-excited high-pressure pneumatic impulse source.

The control apparatus is connected to the sensing radar gimbal 4, the nodal geophone 3, the robotic arm 5, the rotating mechanism, and the active seismic source 8, and is configured to: receive environmental data and seismic wave data that are fed back by the sensing radar gimbal 4 and the nodal geophone 3, control an action of the robotic arm 5, and control the rotating mechanism to adjust an excitation direction of the active seismic source 8. A wireless communication module is disposed in the control apparatus. There are a plurality of ad hoc network relay nodes 10, the plurality of ad hoc network relay nodes 10 are deployed to form an ad hoc network, and the control apparatus is in a wireless connection to a ground monitoring center through the ad hoc network. A signal strength detection module is disposed in the ad hoc network relay node 10, and is configured to: measure signal strength of a position at which the ad hoc network relay node is located, and feed back the signal strength to the control apparatus. The control apparatus is configured to determine a placing position of the ad hoc network relay node 10 according to the signal strength. The signal strength detection module is further configured to detect a network signal after a turn point appears in a traveling path of the unmanned detection carrier platform 7 or the unmanned detection carrier platform 7 is moved by a fixed distance. If detected signal strength is poor, the unmanned detection carrier platform 7 stops, and one ad hoc network relay node 10 is deployed by the robotic arm 5 on a bottom plate at a current position to enhance network connection. Then, the unmanned detection carrier platform 7 continues to travel until the ad hoc network is formed in the underground space. This ensures that the unmanned detection carrier platform 7 is not disconnected due to network anomaly in a process of moving in the underground space.

As an improvement of the present disclosure, the ad hoc network relay node 10 is provided with a global positioning system (GPS) timing module, and a high-precision crystal oscillator timing module. When the ad hoc network relay node 10 is within a signal range of a GPS, timing is performed by the GPS timing module according to a GPS signal. When the ad hoc network relay node 10 is in a satellite-denied environment, timing is performed by the high-precision crystal oscillator timing module. Time synchronization is kept through timing, and a time error within 24 hours is controlled to be within 2 ms, to meet needs of sensing and detection in the underground space.

As an improvement of the present disclosure, the nodal geophone 3 is a wireless three-component geophone, and can be configured to implement vector reception of seismic signals from different directions of the entire space. In addition, the nodal geophone 3 is provided with the GPS timing module and the high-precision crystal oscillator timing module, and can be configured to provide accurate synchronization time for different seismic signals. The crawler track 6 of the unmanned detection carrier platform 7 is equipped with front and rear swing arms to improve a passing capability under a rugged terrain.

A working method of the unmanned sensing and detection system in underground specifically includes the following steps:
In step 1, unmanned sensing modeling and network deployment in the underground space are performed: The unmanned sensing and detection system is enabled to enter the underground space according to existing underground space documentation; an ad hoc network relay node 10 is deployed according to signal strength in the entering process to construct an ad hoc network of the underground space, to ensure that a ground monitoring center is in continuous wireless communication with a control apparatus; and then, surface data (for example, space, temperature, humidity, and gas) of the underground space is continuously sensed through cooperation between a sensing radar gimbal 4 of the unmanned sensing and detection system and an unmanned aerial vehicle, and the surface data is fed back to the control apparatus to preliminary form a three-dimensional model of the underground space, providing background data and environmental information for subsequent detection.
In step 2, a target to-be-detected underground area is determined: Probability of potential geological anomalies in surrounding rocks across different areas is analyzed according to the existing underground space documentation and the three-dimensional model established in step 1, and the to-be-detected target area is determined.
In step 3, a seismic observation system is deployed and transient electromagnetic data is obtained: The unmanned sensing and detection system is enabled to reach the target area according to the three-dimensional model and a target area planning and navigation path; a robotic arm 5 is controlled by the control apparatus to deploy a nodal geophone 3 around the target area, the unmanned aerial vehicle is started to carry the nodal geophone 3 to fly to a ceiling of the underground space of the target area, and is adsorbed to a ceiling 2 through air pressure to couple the nodal geophone 3 to a surface of the ceiling 2, so that the seismic observation system is formed; and the robotic arm 5 is controlled by the control apparatus in the target area to move a transient electromagnetic detection apparatus to a target rock mass, and the transient electromagnetic detection apparatus is started to obtain the transient electromagnetic data of the target area.
In step 4, an unmanned vector source is excited: The unmanned sensing and detection system is moved to a position at which a seismic wave needs to be excited, an excitation direction of the seismic wave is determined, and a rotating mechanism is controlled by the control apparatus to adjust an excitation direction of an active seismic source 8, to enable the excitation direction to aim at the target rock mass; and the seismic wave is excited by the active seismic source 8 after the alignment, and seismic wave data is continuously received by the seismic observation system to complete detection on a current target area.
In step 5, a detection device is retrieved: The active seismic source 8 is returned by the rotating mechanism, the unmanned sensing and detection system is enabled to move to a position of each nodal geophone 3, and the nodal geophone 3 is retrieved by the robotic arm 5 to an unmanned detection carrier platform.
In step 6, detection is continuously performed in the underground space: Step 2 to step 5 are continuously repeated, different target areas are continuously detected by the unmanned sensing and detection system until detection work of the entire underground space is completed; and then the unmanned sensing and detection system is enabled to start exiting the underground space, and start to sequentially retrieve each ad hoc network relay node 10 from a position of an ad hoc network relay node 10 that is furthest away from an entry of the underground space in an exit process until all ad hoc network relay nodes 10 are retrieved, and the unmanned sensing and detection system completely leaves the underground space.

The above is only the preferred implementation of the present disclosure. It should be noted that: those skilled in the art may make several improvements and modifications without departing from the principle of the present disclosure, and these improvements and modifications should also be deemed as falling within the protection scope of the present disclosure.

1. An working method of an unmanned sensing and detection system for underground spaces, comprising: yp2 step 1, performing unmanned sensing modeling and network deployment in the underground space:
enabling the unmanned sensing and detection system to enter the underground space according to existing underground space documentation;
deploying ad hoc network relay nodes according to signal strength in an entering process to construct an ad hoc network of the underground space, to ensure that a ground monitoring center is in continuous wireless communication with a control apparatus;
continuously sensing surface data of the underground space through cooperation between a sensing radar gimbal of the unmanned sensing and detection system and an unmanned aerial vehicle, and feeding back the surface data to the control apparatus to preliminary form a three-dimensional model of the underground space;
step 2, determining a target to-be-detected underground area:
analyzing, according to the existing underground space documentation and the three-dimensional model, probability of potential geological anomalies in surrounding rocks across different areas, and determining a to-be-detected target area;
step 3, deploying a seismic observation system and obtaining transient electromagnetic data:
enabling the unmanned sensing and detection system to reach the target area according to the three-dimensional model and a target area planning and navigation path;
controlling the robotic arm by the control apparatus to deploy the nodal geophone around the target area, starting the unmanned aerial vehicle to carry the nodal geophone to fly to a ceiling of the underground space of the target area, thereby forming the seismic observation system; and
controlling, by the control apparatus in the target area, the robotic arm to move the transient electromagnetic detection apparatus to a target rock mass, and starting the transient electromagnetic detection apparatus to obtain the transient electromagnetic data of the target area;
step 4, exciting an unmanned vector source:
moving the unmanned sensing and detection system to a position at which a seismic wave needs to be excited, determining an excitation direction of the seismic wave, and controlling, by the control apparatus, the rotating mechanism to adjust an excitation direction of the active seismic source, to enable the excitation direction to aim at the target rock mass, and
exciting, by the active seismic source, the seismic wave after the alignment, and continuously receiving, by the seismic observation system, seismic wave data, to complete detection on a current target area;
step 5, retrieving a detection device:
returning, by the rotating mechanism, the active seismic source, enabling the unmanned sensing and detection system to move to a position of each nodal geophone, and
retrieving, by the robotic arm, the nodal geophone to the unmanned detection carrier platform; and
step 6, continuously detecting in the underground space:
continuously repeating step 2 to step 5,
continuously detecting, by the unmanned sensing and detection system, different target areas until detection work of the entire underground space is completed,
enabling the unmanned sensing and detection system to start exiting the underground space, and
starting to sequentially retrieve each ad hoc network relay node from a position of an ad hoc network relay node that is furthest away from an entry of the underground space in an exit process until all ad hoc network relay nodes are retrieved, and the unmanned sensing and detection system completely leaves the underground space, wherein
the unmanned sensing and detection system for the underground space comprises
the unmanned detection carrier platform;
the control apparatus;
the sensing radar gimbal;
the robotic arm;
the active seismic source;
the nodal geophone;
the ad hoc network relay node; and
the transient electromagnetic detection apparatus, wherein
the control apparatus is connected to the sensing radar gimbal, the nodal geophone, the robotic arm, the rotating mechanism, and the active seismic source, and is configured to:
receive environmental data and seismic wave data fed back by the sensing radar gimbal and the nodal geophone,
control an action of the robotic arm, and
control the rotating mechanism to adjust an excitation direction of the active seismic source.

2. The working method according to claim 1, wherein
wherein the nodal geophone, the ad hoc network relay node, and the transient electromagnetic detection apparatus are all disposed on the unmanned detection carrier platform, and the sensing radar gimbal is disposed on the unmanned detection carrier platform, and is configured to obtain ambient environmental data; and
the robotic arm is disposed on the unmanned detection carrier platform, and is configured to:
place the nodal geophone and the ad hoc network relay node on required positions, and move the transient electromagnetic detection apparatus to a required position for transient electromagnetic detection, and
wherein the unmanned sensing and detection system further comprises
a drone port is disposed on the unmanned detection carrier platform, an unmanned aerial vehicle is stationed on the drone port, and
the unmanned aerial vehicle is configured to carry a sensing device to sense the underground space to obtain data, and carry the nodal geophone to fly to a side wall or a ceiling of the underground space to construct a seismic observation system, and
the active seismic source is disposed beside the unmanned detection carrier platform through a rotating mechanism, and is configured to excite seismic waves in different directions via the rotating mechanism according to needs;
a wireless communication module is disposed in the control apparatus;
there are a plurality of ad hoc network relay nodes, the plurality of ad hoc network relay nodes are deployed to form an ad hoc network, and the control apparatus is in a wireless connection to a ground monitoring center through the ad hoc network; and
a signal strength detection module is disposed in the ad hoc network relay node, and is configured to:
measure signal strength of a position at which the ad hoc network relay node is located and feed back the signal strength to the control apparatus; and
the control apparatus is configured to determine a placing position of the ad hoc network relay node according to the signal strength; and
the ad hoc network relay node is provided with a global positioning system (GPS) timing module, and a high-precision crystal oscillator timing module;
when the ad hoc network relay node is within a signal range of a GPS, timing is performed by the GPS timing module according to a GPS signal; and
when the ad hoc network relay node is in a satellite-denied environment, timing is performed by the high-precision crystal oscillator timing module.

3. The working method according to claim 1, further comprising:
a crawler track is disposed on a lower part of the unmanned detection carrier platform, and is configured to move the unmanned detection carrier platform.

4. The working method according to claim 1, further comprising:
a plurality of nodal geophones, wherein
the plurality of nodal geophones are deployed to form a seismic observation system for receiving seismic wave data excited by the active seismic source.

5. (canceled)

6. (canceled)

7. The working method according to claim 1, wherein the control apparatus is a high-performance computer.

8-20. (canceled)
